(19) United States
(12) Patent Application Publication
(10) Pub. No.: US 2024/0120472 A1
(43) Pub. Date: Apr. 11, 2024

(54) BATTERY AND METHOD FOR MANUFACTURING THE SAME

(71) Applicant: Panasonic Intellectual Property Management Co., Ltd., Osaka (JP)

(72) Inventors: SHUJI ITO, Nara (JP); TADAAKI MATSUMURA, Shiga (JP); YUSUKE ITO, Nara (JP)

(21) Appl. No.: 18/542,605

(22) Filed: Dec. 16, 2023

Related U.S. Application Data
(63) Continuation of application No. PCT/JP2022/019755, filed on May 10, 2022.

(30) Foreign Application Priority Data
Jul. 7, 2021 (JP) 2021-113024

(51) Int. Cl. H01M 4/38; H01M 4/04; H01M 4/62; H01M 4/66; H01M 10/052; H01M 10/0562

(52) U.S. Cl. CPC H01M 4/386; H01M 4/0404; H01M 4/0421; H01M 4/626; H01M 4/661; H01M 10/052; H01M 10/0562; H01M 2004/027

(57) ABSTRACT

A battery includes a positive electrode, a negative electrode, and an electrolyte layer located between the positive electrode and the negative electrode. The negative electrode includes a negative electrode current collector and a negative electrode active material layer located between the negative electrode current collector and the electrolyte layer. The negative electrode active material layer includes a plurality of columnar bodies. The columnar bodies include silicon and a filler including nickel. The filler is embedded in the columnar bodies.

### BACKGROUND

### 1. Technical Field

The present disclosure relates to a battery and a method for manufacturing the same.

### 2. Description of the Related Art

WO 2012/117991 discloses that a negative electrode active material for lithium ion secondary batteries that includes silicon and a metal can be prepared by such a method as plasma CVD or gas atomization. In WO 2012/117991, the negative electrode active material is mixed with a carbon-containing conductive material to give a coating liquid, and a negative electrode is fabricated using the coating liquid.

WO 2016/098212 discloses a lithium secondary battery that has a negative electrode which includes a Si-containing alloy containing silicon and tin. In the Si-containing alloy of WO 2016/098212, silicide phases including a transition metal silicide are dispersed.

WO 2007/055007 discloses negative electrode active material particles for lithium secondary batteries in which low-melting metal particles and a carbon material adhere to the surface of alloy particles containing silicon. In WO 2007/055007, the alloy particles are prepared by such a method as mechanical alloying.

### SUMMARY

One non-limiting and exemplary embodiment provides a battery improved in cycle characteristics.

In one general aspect, the techniques disclosed here feature a battery including a positive electrode, a negative electrode, and an electrolyte layer located between the positive electrode and the negative electrode, wherein the negative electrode includes a negative electrode current collector and a negative electrode active material layer located between the negative electrode current collector and the electrolyte layer, the negative electrode active material layer includes a plurality of columnar bodies, the columnar bodies include silicon and a filler including nickel, and the filler is embedded in the columnar bodies.

The battery provided according to the present disclosure has improved cycle characteristics.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a schematic sectional view of a battery according to an embodiment;

FIG. 2A is a schematic sectional view of a negative electrode according to the embodiment;

FIG. 2B is a schematic sectional view of a negative electrode according to a modified embodiment;

FIG. 3 is a flowchart of a method for manufacturing a battery according to the embodiment;

FIG. 4A is a scanning electron microscope (SEM) image of a cross section of a negative electrode in a battery of Sample 1;

FIG. 4B is an image illustrating results of Si mapping on the SEM image of FIG. 4A;

FIG. 4C is an image illustrating results of Ni mapping on the SEM image of FIG. 4A;

FIG. 5A is a SEM image of a cross section of a negative electrode in a battery of Sample 3;

FIG. 5B is an image illustrating results of Si mapping on the SEM image of FIG. 5A;

FIG. 5C is an image illustrating results of Cu mapping on the SEM image of FIG. 5A;

FIG. 6A is a SEM image of a cross section of a negative electrode in a battery of Sample 2;

FIG. 6B is an image illustrating results of Si mapping on the SEM image of FIG. 6A;

FIG. 6C is an image illustrating results of Ni mapping on the SEM image of FIG. 6A; and

FIG. 6D is an image illustrating results of Cu mapping on the SEM image of FIG. 6A.

### DETAILED DESCRIPTIONS

### Underlying Knowledge Forming Basis of the Present Disclosure

The development of automobile lithium secondary batteries having such characteristics as high safety, high performance, and long life is an urgent necessity in order to deal with the rapid spread of electric vehicles (EV). Furthermore, the extension in cruising distance per charge and the shortening of charging time are required in order to enhance EV convenience. In order for lithium secondary batteries to have high energy density or high capacity, importance lies in the development of negative electrode materials having high capacity. For example, silicon is a promising negative electrode material having high capacity. Unfortunately, it is difficult for negative electrode active materials including silicon to achieve both high capacity and excellent long-term cycle characteristics.

As described hereinabove, WO 2012/117991 discloses a negative electrode active material for lithium ion secondary batteries that includes silicon and a metal. WO 2016/098212 discloses a lithium secondary battery that has a negative electrode which includes a Si-containing alloy containing silicon and tin. In the Si-containing alloy of WO 2016/098212, silicide phases including a transition metal silicide are dispersed. WO 2007/055007 discloses negative electrode active material particles for lithium secondary batteries in which low-melting metal particles and a carbon material adhere to the surface of alloy particles containing silicon.

In the configurations of WO 2012/117991, WO 2016/098212, and WO 2007/055007, the negative electrode active materials contain an additional element in combination with silicon. These additional elements cause a decrease in negative electrode capacity. In WO 2012/117991, WO 2016/098212, and WO 2007/055007, silicon is alloyed with the additional metal to form silicide phases. Thus, the additional metals contribute little to improving the electron conductivity of the alloy that is obtained. In WO 2012/117991, WO 2016/098212, and WO 2007/055007, furthermore, the alloying of silicon forms nanosized alloy particles. Thus, electrode fabrication requires the addition of a carbon material, a metal, or other material capable of joining the alloy particles together. This addition tends to lower the capacity per volume and the capacity per mass below the expected negative electrode performance. WO 2012/117991, WO 2016/098212, and WO 2007/055007 disclose results of a charge-discharge test in which a battery was subjected to up to 100 cycles of charging and discharging. It seems that the batteries according to WO 2012/117991, WO 2016/098212, and WO 2007/055007 will have problems in durability after an increased number of cycles.

The present inventors studied approaches to improving cycle characteristics of batteries that have a negative electrode including silicon. As a result, the present inventors have newly found that cycle characteristics are advantageously improved by designing a negative electrode active material layer so that the negative electrode active material layer has columnar bodies including silicon, and nickel is localized at a plurality of locations within the negative electrode active material layer. The present inventors carried out further studies based on the newly found knowledge and have completed the battery of the present disclosure.

### Summary of Aspects of the Present Disclosure

A battery according to the first aspect of the present disclosure includes:

a positive electrode;

a negative electrode; and

an electrolyte layer located between the positive electrode and the negative electrode, wherein

the negative electrode includes a negative electrode current collector and a negative electrode active material layer located between the negative electrode current collector and the electrolyte layer,

the negative electrode active material layer includes a plurality of columnar bodies,

the columnar bodies include silicon and a filler including nickel, and

the filler is embedded in the columnar bodies.

According to the first aspect, the filler including nickel is embedded in the columnar bodies. Thus, the filler is unlikely to be detached from the columnar bodies even when the battery is repeatedly charged and discharged. The conductivity stemming from the filler is maintained, and the cycle characteristics of the battery are improved. In particular, the battery tends to have excellent long-term cycle characteristics. The battery also tends to have high capacity.

In the second aspect of the present disclosure, for example, the battery according to the first aspect may be such that the columnar bodies include a matrix surrounding the filler, and the matrix includes the silicon.

In the third aspect of the present disclosure, for example, the battery according to the first or the second aspect may be such that the negative electrode active material layer is essentially free from an electrolyte.

In the fourth aspect of the present disclosure, for example, the battery according to any one of the first to the third aspects may be such that the columnar bodies in the negative electrode active material layer are aligned along a surface of the negative electrode current collector.

In the fifth aspect of the present disclosure, for example, the battery according to any one of the first to the fourth aspects may be such that the columnar bodies include the silicon as a main component.

In the sixth aspect of the present disclosure, for example, the battery according to any one of the first to the fifth aspects may be such that the filler includes the nickel as a main component.

In the seventh aspect of the present disclosure, for example, the battery according to any one of the first to the sixth aspects may be such that the filler has a particulate shape.

In the eighth aspect of the present disclosure, for example, the battery according to any one of the first to the seventh aspects may be such that the negative electrode current collector includes nickel.

In the ninth aspect of the present disclosure, for example, the battery according to any one of the first to the eighth aspects may be such that the negative electrode current collector includes a substrate and a coating layer covering the substrate and including nickel.

In the tenth aspect of the present disclosure, for example, the battery according to any one of the first to the ninth aspects may be such that the electrolyte layer includes a solid electrolyte having lithium ion conductivity.

In the eleventh aspect of the present disclosure, for example, the battery according to any one of the first to the tenth aspects may be such that the electrolyte layer includes a sulfide solid electrolyte.

The batteries according to the second to the eleventh aspects attain improved cycle characteristics. In particular, the batteries tend to have excellent long-term cycle characteristics. The batteries also tend to have high capacity.

A method for manufacturing a battery according to the twelfth aspect of the present disclosure includes:

forming a thin film including silicon on a negative electrode current collector including nickel;

preparing a laminated body including the negative electrode current collector, the thin film, an electrolyte layer, and a positive electrode; and

forming a plurality of columnar bodies from the thin film by charging and discharging the laminated body, the columnar bodies including silicon and a filler including nickel.

According to the twelfth aspect, a battery improved in cycle characteristics can be manufactured.

In the thirteenth aspect of the present disclosure, for example, the manufacturing method according to the twelfth aspect may be such that the thin film is formed by depositing silicon onto the negative electrode current collector by a vapor-phase method.

In the fourteenth aspect of the present disclosure, for example, the manufacturing method according to the twelfth or the thirteenth aspect may be such that the laminated body is charged and discharged while applying a pressure to the laminated body.

According to the thirteenth or the fourteenth aspect, a battery improved in cycle characteristics can be manufactured.

Hereinafter, an embodiment of the present disclosure will be described with reference to the drawings. The present disclosure is not limited to the embodiment described below.

### Embodiment

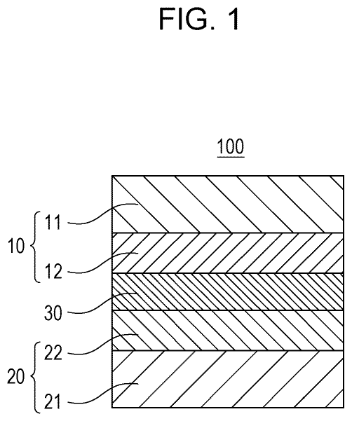

FIG. 1 is a schematic sectional view of a battery 100 according to an embodiment. As illustrated in FIG. 1, the battery 100 includes a positive electrode 10, a negative electrode 20, and an electrolyte layer 30. The electrolyte layer 30 is located between the positive electrode 10 and the negative electrode 20. The negative electrode 20 includes a negative electrode current collector 21 and a negative electrode active material layer 22. The negative electrode active material layer 22 is located between the negative electrode current collector 21 and the electrolyte layer 30.

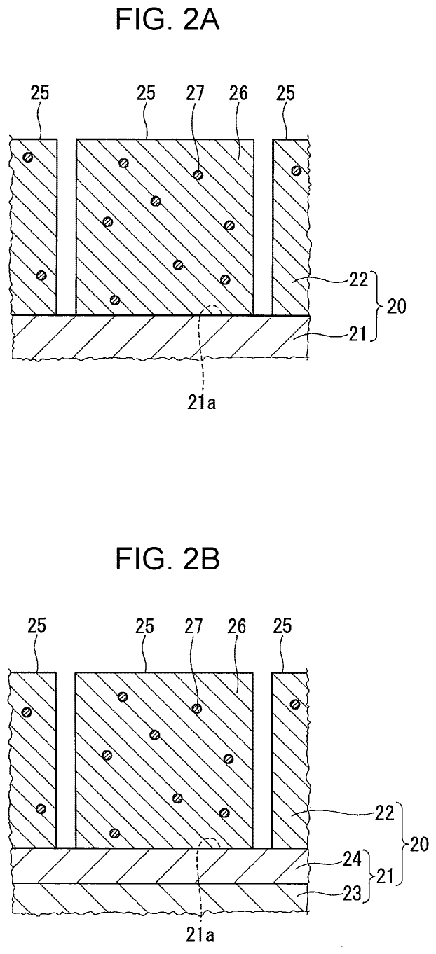

FIG. 2A is a schematic sectional view of the negative electrode 20 according to the present embodiment. As illustrated in FIG. 2A, the negative electrode active material layer 22 includes a plurality of columnar bodies 25. The columnar bodies 25 include silicon and a filler 27 including nickel. The filler 27 is embedded in the columnar bodies 25. Specifically, the columnar bodies 25 include a matrix 26 surrounding the filler 27. The matrix 26 includes silicon.

In the present embodiment, the filler 27 is embedded within the columnar bodies 25. That is, nickel is localized at a plurality of locations within the columnar bodies 25. The silicon itself contained in the matrix 26 is a semiconductor and has poor electron conductivity. In the present embodiment, however, electron conductive nickel is present inside the columnar bodies 25 and thus the electron conductivity of the negative electrode active material layer 22 is enhanced. Silicon may form an alloy with lithium. Thus, the matrix 26 in the battery 100 may change its volume when silicon absorbs and releases lithium. In the present embodiment, the filler 27 is embedded in the columnar bodies 25 and is therefore unlikely to be detached from the columnar bodies 25 even when the volume of the matrix 26 changes significantly due to charging and discharging of the battery 100. In this manner, the negative electrode active material layer 22 can easily maintain conductivity, and the battery 100 attains improved cycle characteristics. In particular, the battery 100 tends to have excellent long-term cycle characteristics.

For example, the columnar bodies 25 are in contact with the negative electrode current collector 21 and extend in the thickness direction of the negative electrode current collector 21. The columnar bodies 25 may be inclined with respect to the thickness direction of the negative electrode current collector 21. The shape of the columnar bodies 25 may be prismatic or cylindrical.

In the present embodiment, the columnar bodies 25 in the negative electrode active material layer 22 are aligned along a surface 21a of the negative electrode current collector 21. That is, the surface 21a of the negative electrode current collector 21 is covered with the columnar bodies 25. The columnar bodies 25 may cover the entirety of the surface 21a of the negative electrode current collector 21 or may cover part of the surface 21a. A gap may be present between any two adjacent columnar bodies 25 among the columnar bodies 25.

For example, the negative electrode active material layer 22 is composed of a plurality of columnar bodies 25. The negative electrode active material layer 22 is typically a collection of a plurality of columnar bodies 25 covering the surface of the negative electrode current collector 21. For example, the negative electrode active material layer 22 is a single layer composed of a plurality of columnar bodies 25. According to the negative electrode active material layer 22 of the present embodiment, the electrolyte layer 30 and the negative electrode current collector 21 are unlikely to come into direct contact with each other, and the battery 100 can attain high energy density more reliably.

As described above, the columnar bodies 25 include the matrix 26 and the filler 27. The filler 27 is embedded in the matrix 26. The filler 27 is surrounded by the matrix 26. The filler 27 is dispersed in the matrix 26. In FIG. 2A, masses of the filler 27 are separate from one another. Masses of the filler 27 may be in contact with one another. In the columnar bodies 25, for example, the filler 27 is in close contact with the matrix 26. At least part of the surface of the filler 27 is in contact with the matrix 26. As an example, the entire surface of the filler 27 is in contact with the matrix 26. For example, there are essentially no voids or cracks between the matrix 26 and the filler 27. In other words, for example, the columnar bodies 25 have a dense structure. With this configuration, the battery 100 may attain excellent cycle characteristics more reliably.

In the matrix 26, for example, silicon forms a continuous phase. In this case, Li ion conduction pathways are formed in the continuous silicon phase. In other words, Li ion conduction pathways are ensured inside the columnar bodies 25. Because of the conduction pathways, the negative electrode active material layer 22 can easily conduct Li ions through the inside thereof. It is, however, not necessary that all the silicon in the matrix 26 form a continuous phase. In the matrix 26, some silicon may form discontinuous phases.

In the matrix 26, silicon may be present essentially as elemental silicon. That is, silicon in the matrix 26 may not be essentially in the form of an intermetallic compound or a solid solution with a metal, such as nickel. Elemental silicon can absorb a larger amount of lithium than in the form of an intermetallic compound or a solid solution with a metal.

The matrix 26 may include amorphous silicon. In the present disclosure, the term “amorphous” is not limited to indicating that the substance is completely free from crystal structures, but also means that the substance may have a short-range order crystalline region. For example, an amorphous substance is a substance that does not show a sharp peak assigned to a crystal and shows a broad peak assigned to an amorphous phase in X-ray diffractometry (XRD). In the present disclosure, the phrase “include amorphous silicon” means that at least part of the matrix 26 is composed of amorphous silicon. In the present embodiment, all the silicon present in the matrix 26 may be amorphous.

The matrix 26 may be free from crystalline silicon. The matrix 26 may be essentially composed solely of amorphous silicon. The matrix 26 being essentially composed solely of amorphous silicon can be determined in the following manner. First, XRD measurement is performed with respect to randomly selected portions (for example, 50 portions) of the negative electrode active material layer 22. When the portions that are measured do not show a sharp peak at all, the matrix 26 can be judged as being essentially composed solely of amorphous silicon.

For example, the matrix 26 includes silicon as a main component. In the present specification, the term “main component” means that the component represents the largest mass ratio among all the components. The matrix 26 may essentially include only silicon. The phrase “essentially include only silicon” permits mixing of trace amounts of incidental impurities. The presence of silicon in the matrix 26 can be confirmed by elemental analysis, such as energy-dispersive X-ray spectroscopy (EDX).

Because of the matrix 26, in the present embodiment, the negative electrode active material layer 22 may include silicon as a main component, and the columnar bodies 25 may include silicon as a main component. From the point of view of energy density, the content of silicon in the negative electrode active material layer 22 may be greater than or equal to 80 mass % or may be greater than or equal to 95 mass %. The upper limit of the content of silicon in the negative electrode active material layer 22 is not particularly limited and is, for example, 99 mass %, and may be 95 mass % in some cases. The content of silicon in the columnar bodies 25 may be greater than or equal to 80 mass % or may be greater than or equal to 95 mass %. The upper limit of the content of silicon in the columnar bodies 25 is not particularly limited and is, for example, 99 mass %, and may be 95 mass % in some cases. With the above configuration, the initial discharge capacity of the battery 100 can be enhanced. For example, the content of silicon can be determined by inductively coupled plasma (ICP) emission spectroscopy.

The content of the matrix 26 in the columnar bodies 25 is not particularly limited and is, for example, greater than or equal to 80 mass %, and may be greater than or equal to 95 mass %. The upper limit of the content of the matrix 26 in the columnar bodies 25 is not particularly limited and is, for example, 99 mass %, and may be 95 mass % in some cases.

Nickel present in the filler 27 imparts electron conductivity to the columnar bodies 25. Thus, the electron conductivity of the negative electrode active material layer 22 can be enhanced. In the filler 27, nickel may be present essentially as elemental nickel. That is, nickel in the filler 27 may not be essentially in the form of an intermetallic compound or a solid solution with silicon. Elemental nickel can exhibit higher electron conductivity than in the form of an intermetallic compound or a solid solution with silicon.

In the negative electrode active material layer 22 of the present embodiment, the filler 27 is embedded in the matrix 26. Thus, nickel itself is not uniformly dispersed in the negative electrode active material layer 22. That is, it can be said that nickel forms discontinuous phases in the negative electrode active material layer 22. As an example, nickel regions as discontinuous phases are localized within the silicon continuous phase in the columnar bodies 25. Incidentally, nickel does not usually form an alloy with lithium. Thus, nickel probably has no lithium ion conductivity.

For example, the filler 27 includes nickel as a main component. The filler 27 may essentially include only nickel. The presence of nickel in the filler 27 can be confirmed by elemental analysis, such as EDX.

Because of the filler 27, the negative electrode active material layer 22 in the present embodiment includes nickel. The content of nickel in the negative electrode active material layer 22 may be less than or equal to 20 mass % from the points of view of energy density and rate characteristics. Nickel does not have ion conductivity and tends to inhibit the conduction of Li ions. Thus, the content of nickel may be less than or equal to 10 mass %. The above configuration can ensure excellent cycle characteristics over a long period of time while reducing the decrease in energy density of the battery 100. The lower limit of the content of nickel in the negative electrode active material layer 22 is not particularly limited and is, for example, 0.5 mass %, and may be 1 mass %. For example, the content of nickel can be determined by inductively coupled plasma (ICP) emission spectroscopy.

The content of the filler 27 in the columnar bodies 25 is not particularly limited and is, for example, less than or equal to 20 mass %, and may be less than or equal to 10 mass %. The lower limit of the content of the filler 27 in the columnar bodies 25 is not particularly limited and is, for example, 0.5 mass %, and may be 1 mass %.

The shape of the filler 27 is not particularly limited. For example, the filler 27 has a particulate shape. The shape of the filler 27 may be other shape, such as acicular, spherical, ellipsoidal, or fibers. When the filler 27 has a particulate shape, the average particle size of the filler 27 is, for example, greater than or equal to 50 nm and less than or equal to 3000 nm and may be greater than or equal to 50 nm and less than or equal to 2000 nm. The average particle size of the filler 27 can be determined in the following manner. First, a cross section of the negative electrode active material layer 22 is observed with a scanning electron microscope (SEM). The cross section of the negative electrode active material layer 22 is one that is parallel to the thickness direction of the negative electrode active material layer 22. The SEM image obtained is analyzed to calculate the area of a particular particle of the filler 27 by image processing. The diameter of a circle having the same area as the calculated area is taken as the particle diameter of the particular particle of the filler 27. The particle diameter is calculated with respect to a predetermined number (for example, 50) of particles of the filler 27, and the calculated values are averaged to give the average particle size of the filler 27.

The negative electrode active material layer 22 may essentially include only silicon and nickel. The phrase “essentially include only silicon and nickel” permits mixing of trace amounts of incidental impurities. The negative electrode active material layer 22 may further include incidental impurities, or starting materials, by-products, and decomposition products that are used or occur in the formation of the negative electrode active material layer 22. For example, the negative electrode active material layer 22 may include oxygen or a dissimilar metal.

For example, the negative electrode active material layer 22 is essentially free from an electrolyte. In the present specification, the term “electrolyte” includes solid electrolyte and nonaqueous electrolyte. The phrase “essentially free from” permits mixing of a trace amount of an electrolyte. In particular, the negative electrode active material layer 22 may be essentially free from an electrolyte after the fabrication of the battery 100 and before the initial charging and discharging of the battery 100. According to the above configuration, the battery 100 has high energy density due to the high content of silicon in the negative electrode active material layer 22. Furthermore, according to the above configuration, the essential absence of an electrolyte, for example, a solid electrolyte, such as a sulfide solid electrolyte, in the negative electrode active material layer 22 may reduce or eliminate contacts between the metal in the negative electrode current collector 21 and a sulfide solid electrolyte. As a result, no or little sulfides are generated by charging and discharging of the battery 100, and the battery 100 can maintain rate characteristics and cycle characteristics over a long period of time.

During repeated charging and discharging of the battery 100, part of the material forming the electrolyte layer 30 may move to the negative electrode active material layer 22. Thus, the negative electrode active material layer 22 may further include an electrolyte of origin from the electrolyte layer 30. For example, this electrolyte is a solid electrolyte. As an example, the mass of the electrolyte mixed from the electrolyte layer 30 into the negative electrode active material layer 22 is variable depending on the number of charge-discharge cycles but is, for example, less than or equal to 10 mass % relative to the total mass of the negative electrode active material layer 22.

For example, the thickness of the negative electrode active material layer 22 is greater than or equal to 4 μm. The upper limit of the thickness of the negative electrode active material layer 22 may be 30 μm or may be 10 μm. With the above configuration, the battery 100 can attain a small decrease from the initial discharge capacity. The thickness of the negative electrode active material layer 22 can be determined in the following manner. First, a cross section of the negative electrode active material layer 22 is observed with a scanning electron microscope (SEM). The cross section of the negative electrode active material layer 22 is one that is parallel to the thickness direction of the negative electrode active material layer 22. With respect to the SEM image obtained, 50 portions of the negative electrode active material layer 22 are randomly selected. The thickness is measured of the randomly selected 50 portions of the negative electrode active material layer 22. The measured values are averaged to give the thickness of the negative electrode active material layer 22.

In the negative electrode active material layer 22, the width of the columnar bodies 25 is, for example, greater than or equal to 3 μm and less than or equal to 30 μm. The width of the columnar bodies 25 indicates the length of the columnar bodies 25 in a direction perpendicular to the direction in which the negative electrode current collector 21 and the negative electrode active material layer 22 are laminated. The width of the columnar bodies 25 can be determined in the following manner. First, a cross section of the negative electrode active material layer 22 is observed with a scanning electron microscope (SEM). The cross section of the negative electrode active material layer 22 is one that is parallel to the thickness direction of the negative electrode active material layer 22. With respect to the SEM image obtained, fifty columnar bodies 25 are randomly selected. The maximum width is measured of each of the randomly selected fifty columnar bodies 25. The measured values are averaged to give the width of the columnar bodies 25.

The material of the negative electrode current collector 21 is typically a metal. The negative electrode current collector 21 may include nickel or may be essentially composed of only nickel. The negative electrode current collector 21 may contain incidental impurities in addition to nickel.

A metal foil may be used as the negative electrode current collector 21. Examples of the metal foils include nickel foils. The nickel foil may be an electrolytic nickel foil. For example, an electrolytic nickel foil can be produced in the following manner. First, a metal drum is immersed into an electrolyte solution in which nickel ions are dissolved. An electric current is applied to the drum while rotating the drum. In this manner, nickel is deposited onto the surface of the drum. The deposited nickel is peeled to give an electrolytic nickel foil. One side or both sides of the electrolytic nickel foil may be roughened or surface-treated.

The surface of the negative electrode current collector 21 may be roughened. The surface-roughened negative electrode current collector 21 tends to allow the columnar bodies 25 to be formed easily on the negative electrode current collector 21. Furthermore, the surface roughening also tends to enhance the adhesion between the columnar bodies 25 and the negative electrode current collector 21. For example, the surface of the negative electrode current collector 21 may be roughened by electrolytically depositing a metal to form a rough surface of the metal.

For example, the arithmetic average roughness Ra of the surface of the negative electrode current collector 21 is greater than or equal to 0.001 μm. The arithmetic average roughness Ra of the surface of the negative electrode current collector 21 may be greater than or equal to 0.01 μm and less than or equal to 2 μm or may be greater than or equal to 0.1 μm and less than or equal to 1 μm. Appropriate control of the arithmetic average roughness Ra of the surface of the negative electrode current collector 21 can increase the area of contacts between the negative electrode current collector 21 and the negative electrode active material layer 22. In this manner, it is possible to reduce or eliminate the occurrence of separation of the negative electrode active material layer 22 from the negative electrode current collector 21. As a result, the battery 100 may attain high cycle characteristics more reliably. The arithmetic average roughness Ra is a value specified in Japanese Industrial Standards (JIS) B0601: 2013 and can be measured with, for example, a laser microscope.

The thickness of the negative electrode current collector 21 is not particularly limited and may be greater than or equal to 5 μm and less than or equal to 50 μm or may be greater than or equal to 8 μm and less than or equal to 25 μm.

The configuration of the negative electrode 20 is not limited to FIG. 2A. FIG. 2B is a schematic sectional view of a negative electrode 20 according to a modified embodiment. As illustrated in FIG. 2B, a negative electrode current collector 21 in the negative electrode 20 may include a substrate 23 and a coating layer 24 covering the substrate 23. The coating layer 24 may include nickel.

The coating layer 24 may cover the entirety of a principal face of the substrate 23 or may cover part of a principal face of the substrate 23. The term “principal face” means a face of the substrate 23 having the largest area. The coating layer 24 is located between the substrate 23 and the negative electrode active material layer 22 and is in contact with the substrate 23 and with the negative electrode active material layer 22. The shape of the coating layer 24 may be dots, stripes, or other shape.

The coating layer 24 may be essentially composed of only nickel. The coating layer 24 may contain incidental impurities in addition to nickel.

The surface of the coating layer 24 may be roughened. For example, the arithmetic average roughness Ra of the surface of the coating layer 24 is greater than or equal to 0.001 μm. The arithmetic average roughness Ra of the surface of the coating layer 24 may be greater than or equal to 0.01 μm and less than or equal to 2 μm or may be greater than or equal to 0.1 μm and less than or equal to 1 μm. The arithmetic average roughness Ra of the surface of the coating layer 24 can be measured in the manner described hereinabove for the surface of the negative electrode current collector 21.

For example, the coating layer 24 can be formed by plating the surface of the substrate 23 with nickel.

The material of the substrate 23 is typically a metal. Examples of the materials of the substrates 23 include copper, stainless steel, and alloys containing these metals as main components. The substrate 23 may be composed of copper or a copper alloy. Compared to nickel, copper has excellent electron conductivity and also tends to be inexpensive.

For example, copper forms copper sulfide by reacting with a sulfide solid electrolyte. In general, copper sulfide is a substance that may be a resistance in ion conduction. In the battery 100 according to the present embodiment, the negative electrode active material layer 22 is essentially free from an electrolyte, such as, for example, a solid electrolyte. In other words, there are essentially no electrolytes on the surface of the negative electrode current collector 21. Furthermore, the coating layer 24 is present between the substrate 23 and the negative electrode active material layer 22. Thus, the battery 100 according to the present embodiment experiences no or little reaction between the metal contained in the substrate 23 and an electrolyte. Thus, even when the substrate 23 is composed of copper or a copper alloy, charging and discharging of the battery 100 are unlikely to form, for example, copper sulfide. As described above, the battery 100 according to the present embodiment can use a substrate 23 including copper. Because no or little copper sulfide is formed, the battery 100 can attain high capacity and excellent long-term cycle characteristics more reliably.

A metal foil may be used as the substrate 23. Examples of the metal foils include copper foils and copper alloy foils. The copper foil may be an electrolytic copper foil. For example, an electrolytic copper foil can be produced in a manner similar to the above-described method for producing an electrolytic nickel foil.

The electrolyte layer 30 is a layer including an electrolyte. For example, the electrolyte is a solid electrolyte. That is, the electrolyte layer 30 may be a solid electrolyte layer.

For example, the electrolyte layer 30 includes a solid electrolyte having lithium ion conductivity. Examples of the solid electrolytes contained in the electrolyte layers 30 include sulfide solid electrolytes, oxide solid electrolytes, halide solid electrolytes, complex hydride solid electrolytes, and polymeric solid electrolytes. With this configuration, the battery 100 can attain both high capacity and excellent cycle characteristics. The electrolyte layer 30 may include a sulfide solid electrolyte.

Examples of the sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MOₚ, or Li_{q}MOᵣ may be added to the solid electrolytes described above. X includes at least one selected from the group consisting of F, Cl, Br, and I. M is at least one selected from the group consisting of P, Si, Ge, B, Al, Ga, In, Fe, and Zn. The letters p, q, and r are each a natural number.

Examples of the oxide solid electrolytes include Na super ionic conductor (NASICON)-type solid electrolytes typified by LiTi₂(PO₄)₃ and element-substituted derivatives thereof; perovskite-type solid electrolytes including (LaLi)TiO₃; Li super ionic conductor (LISICON)-type solid electrolytes typified by Li₁₄ZnGe₄O₁₆, Li₄SiO₄, LiGeO₄, and element-substituted derivatives thereof; garnet-type solid electrolytes typified by Li₇La₃Zr₂O₁₂ and element-substituted derivatives thereof; Li₃N and H-substituted derivatives thereof; Li₃PO₄ and N-substituted derivatives thereof; and glass and glass ceramics based on Li—B—O compound, such as LiBO₂ or Li₃BO₃, and doped with, for example, Li₂SO₄ or Li₂CO₃.

Examples of the halide solid electrolytes include materials represented by the compositional formula Li_{α}M_{β}X_{γ}. α, β, and γ are each independently a value greater than 0. M includes at least one selected from the group consisting of metal elements except Li, and metalloid elements. X is one, or two or more elements selected from the group consisting of F, Cl, Br, and I. The metalloid elements are B, Si, Ge, As, Sb, and Te. The metal elements are all the elements found in Groups 1 to 12 of the periodic table except hydrogen, and all the elements found in Groups 13 to 16 of the periodic table except B, Si, Ge, As, Sb, Te, C, N, P, O, S, and Se. That is, the metalloid elements or the metal elements are a group of elements that can form an inorganic compound with a halogen compound by becoming a cation.

Specific examples of the halide solid electrolytes include Li₃YX₆, Li₂MgX₄, Li₂FeX₄, Li(Al,Ga,In)X₄, and Li₃(Al,Ga,In)X₆. In the present disclosure, “(Al,Ga,In)” indicates at least one element selected from the group consisting of the elements in parentheses. That is, “(Al,Ga,In)” is synonymous with “at least one selected from the group consisting of Al, Ga, and In”. The same applies to other elements.

Examples of the complex hydride solid electrolytes include LiBH₄—LiI and LiBH₄—P₂S₅.

Examples of the polymeric solid electrolytes include compounds of a polymer compound with a lithium salt. The polymer compound may have an ethylene oxide structure. The polymer compound having an ethylene oxide structure can contain a large amount of a lithium salt, and thus the ionic conductivity can be further increased. Examples of the lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. The lithium salts may be used singly, or two or more may be used in combination.

For example, the shape of the solid electrolyte is particulate. The shape of the solid electrolyte may be other shape, such as acicular, spherical, or ellipsoidal. When the solid electrolyte is particles, the average particle size is, for example, greater than or equal to 0.1 μm and less than or equal to 50 μm.

The positive electrode 10 includes a positive electrode current collector 11 and a positive electrode active material layer 12. The positive electrode active material layer 12 is located between the positive electrode current collector 11 and the electrolyte layer 30.

The material of the positive electrode current collector 11 is not limited to a particular material and may be a material commonly used in batteries. Examples of the materials of the positive electrode current collectors 11 include copper, copper alloys, aluminum, aluminum alloys, stainless steel, nickel, titanium, carbon, lithium, indium, and conductive resins. The shape of the positive electrode current collector 11 is not limited to a particular shape. Examples of the shapes include foils, films, and sheets. The surface of the positive electrode current collector 11 may have irregularities.

For example, the positive electrode active material layer 12 includes a positive electrode active material. For example, the positive electrode active material includes a material capable of occluding and releasing metal ions, such as lithium ions. Examples of the positive electrode active materials include lithium-containing transition metal oxides, transition metal fluorides, polyanion materials, fluorinated polyanion materials, transition metal sulfides, transition metal oxysulfides, and transition metal oxynitrides.

Examples of the lithium-containing transition metal oxides include Li(Ni,Co,Al)O₂, Li(Ni,Co,Mn)O₂, and LiCoO₂. In particular, the use of a lithium-containing transition metal oxide as the positive electrode active material advantageously saves the cost of production of the battery 100 and increases the average discharge voltage of the battery 100. To increase the energy density of the battery 100, the positive electrode active material may include lithium nickel cobalt manganese oxide. For example, the positive electrode active material may be Li(Ni,Co,Mn)O₂.

Where necessary, the positive electrode active material layer 12 may further include at least one selected from the group consisting of solid electrolytes, conductive materials, and binders. The positive electrode active material layer 12 may include a mixed material including positive electrode active material particles and solid electrolyte particles.

For example, the shape of the positive electrode active material is particulate. When the positive electrode active material is particles, the average particle size of the positive electrode active material is, for example, greater than or equal to 100 nm and less than or equal to 50 μm.

The average charge-discharge potential of the positive electrode active material versus the redox potential of Li metal may be greater than or equal to 3.7 V vs. Li/Li⁺. For example, the average charge-discharge potential of the positive electrode active material can be determined by averaging the voltages applied to extract and insert Li from and into the positive electrode active material while using Li metal as the counter electrode. When a material other than Li metal is used as the counter electrode, the average potential can be determined by adding the potential of the counter electrode material versus Li metal to the charge-discharge curves. When a material other than Li metal is used as the counter electrode, the battery may be charged and discharged at a relatively low current in consideration of ohmic loss.

At least one selected from the group consisting of the positive electrode 10, the negative electrode 20, and the electrolyte layer 30 may include a binder for the purpose of enhancing the adhesion of particles to one another. For example, binders are used to enhance the integrity of materials constituting an electrode. Examples of the binders include polyvinylidene fluoride, polytetrafluoroethylene, polyethylene, polypropylene, aramid resins, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene butadiene rubber, and carboxymethylcellulose. Furthermore, the binder that is used may be a copolymer of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. The binders may be used singly, or two or more may be used in combination.

An elastomer may be used as the binder. Elastomer means a polymer having elasticity. The elastomer used as the binder may be a thermoplastic elastomer or a thermosetting elastomer. The binder may include a thermoplastic elastomer. Examples of the elastomers include styrene-ethylene/butylene-styrene block copolymer (SEBS), styrene-ethylene/propylene-styrene block copolymer (SEPS), styrene-ethylene/ethylene/propylene-styrene block copolymer (SEEPS), butylene rubber (BR), isoprene rubber (IR), chloroprene rubber (CR), acrylonitrile-butadiene rubber (NBR), styrene-butylene rubber (SBR), styrene-butadiene-styrene block copolymer (SBS), styrene-isoprene-styrene block copolymer (SIS), hydrogenated isoprene rubber (HIR), hydrogenated butyl rubber (HIIR), hydrogenated nitrile rubber (HNBR), and hydrogenated styrene-butylene rubber (HSBR). A mixture of two or more selected from those described above may be used as the binder.

At least one selected from the group consisting of the positive electrode 10 and the negative electrode 20 may include a conductive auxiliary for the purpose of enhancing the electron conductivity. Examples of the conductive auxiliaries include graphites, carbon blacks, conductive fibers, carbon fluoride, metal powders, conductive whiskers, conductive metal oxides, and conductive polymers. Examples of the graphites include natural graphites and artificial graphites. Examples of the carbon blacks include acetylene blacks and Ketjen blacks. Examples of the conductive fibers include carbon fibers and metal fibers. Examples of the metal powders include aluminum. Examples of the conductive whiskers include zinc oxide and potassium titanate. Examples of the conductive metal oxides include titanium oxide. Examples of the conductive polymer compounds include polyaniline, polypyrrole, and polythiophene. The cost can be reduced by using a conductive auxiliary containing carbon.

Examples of the shapes of the batteries 100 include coin shapes, cylindrical shapes, prismatic shapes, sheet shapes, button shapes, flat shapes, and laminate shapes.

The operating temperature of the battery 100 is not particularly limited. For example, the operating temperature is higher than or equal to −50° C. and lower than or equal to 100° C. With increasing operating temperature of the battery 100, the ion conductivity can be enhanced and the battery 100 tends to be capable of high-output operation.

For example, the area of the principal face of the battery 100 is greater than or equal to 1 cm² and less than or equal to 100 cm². In this case, for example, the battery 100 can be used in portable electronic devices, such as smartphones and digital cameras. The area of the principal face of the battery 100 may be greater than or equal to 100 cm² and less than or equal to 1000 cm². In this case, for example, the battery 100 can be used as a power supply for large movable machines, such as electric vehicles. The “principal face” means the face of the battery 100 that has the largest area.

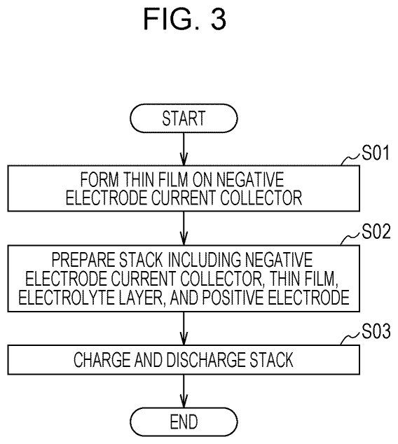

For example, the battery 100 according to the present embodiment may be manufactured by the following method. FIG. 3 is a flowchart of a method for manufacturing a battery 100.

First, in Step S01, a thin film including silicon is formed on a negative electrode current collector 21 including nickel. For example, an electrolytic nickel foil can be used as the negative electrode current collector 21. The surface of the electrolytic nickel foil may be roughened. The surface-roughened electrolytic nickel foil can be produced in the following manner. First, an electrolytic nickel foil is produced by the method described hereinabove. The electrolytic nickel foil obtained is further subjected to electrolysis to deposit nickel on the surface of the electrolytic nickel foil. Thus, a surface-roughened electrolytic nickel foil can be obtained.

The negative electrode current collector 21 may be composed of a substrate 23 that is a copper foil or a copper alloy foil, and a coating layer 24 including nickel. The substrate 23 may be rolled beforehand. For example, this negative electrode current collector 21 can be produced in the following manner. First, a copper foil or a copper alloy foil is provided. By electrolysis, nickel is deposited onto the surface of the foil. In this manner, the copper foil or the copper alloy foil is covered with nickel, and a negative electrode current collector 21 is thus obtained. According to this method, the surface of the coating layer 24 is generally rough.

The thin film may be formed by any method without limitation. For example, a chemical vapor deposition (CVD) method, a sputtering method, a deposition method, a thermal spraying method, or a plating method can be used. The thin film may be formed by depositing silicon onto the negative electrode current collector 21 by a vapor-phase method, such as a CVD method, a sputtering method, or a deposition method. The mass of silicon per area of the thin film is not particularly limited and is, for example, greater than or equal to 0.2 mg/cm² and less than or equal to 5 mg/cm².

Alternatively, the thin film can be formed in the following manner. First, a coating liquid containing silicon particles is prepared. For example, the coating liquid includes an organic solvent, such as N-methylpyrrolidone (NMP). The coating liquid may further include a binder. The coating liquid may be a paste. Next, the coating liquid prepared is applied onto the negative electrode current collector 21, and the resultant coating film is subjected to drying treatment to form a thin film. The conditions for the drying treatment of the coating film can be determined appropriately in accordance with factors, such as the type of the solvent contained in the coating liquid. As an example, the temperature of the drying treatment may be higher than or equal to 80° C. and lower than or equal to 150° C. The drying treatment time may be greater than or equal to 1 hour and less than or equal to 24 hours.

Next, in Step S02, a laminated body is prepared that includes the negative electrode current collector 21, the thin film, an electrolyte layer 30, and a positive electrode 10. For example, this laminated body can be prepared in the following manner. First, a solid electrolyte powder is added to an electrically insulating cylinder. The solid electrolyte powder is pressed to form an electrolyte layer 30. Next, the structure composed of the negative electrode current collector 21 and the thin film is added into the cylinder. The inside of the cylinder is pressed to form a laminated body having the negative electrode current collector 21, the thin film, and the electrolyte layer 30. Next, a positive electrode active material powder and a positive electrode current collector 11 are added into the cylinder. The inside of the cylinder is pressed to form a laminated body including the negative electrode current collector 21, the thin film, the electrolyte layer 30, and a positive electrode 10. Alternatively, a positive electrode active material powder and a positive electrode current collector 11 may be added into the cylinder together with the structure composed of the negative electrode current collector 21 and the thin film, and the inside of the cylinder may be pressed to form a laminated body. In the laminated body, the negative electrode current collector 21, the thin film, the electrolyte layer 30, and the positive electrode 10 are laminated in this order.

Next, the inside of the electrically insulating cylinder is isolated from the outside atmosphere and is sealed with use of an electrically insulating ferrule. Next, in Step S03, the laminated body is charged and discharged. This charging and discharging causes nickel contained in the negative electrode current collector 21 to migrate into the thin film. The nickel that has migrated into the thin film forms phases different from the silicon phase in the thin film and is localized in the inside of the thin film. In this manner, a plurality of columnar bodies 25 are formed. When the thin film includes silicon particles, the silicon particles are bound to one another by the charging and discharging. As described above, a negative electrode active material layer 22 is formed from the thin film by charging and discharging. A battery 100 can be thus obtained.

In Step S03, the charging and discharging may be performed while applying a pressure to the laminated body. For example, the pressure is applied in the same direction as the direction in which the layers are laminated. The pressure applied to the laminated body is not particularly limited and is, for example, greater than or equal to 50 MPa and less than or equal to 300 MPa.

Nickel contained in the negative electrode current collector 21 migrates into the thin film probably by the following mechanism. When the laminated body is charged and discharged, silicon contained in the thin film expands and contracts along with the charging and discharging. In the present embodiment, the thin film is arranged between the negative electrode current collector 21 and the electrolyte layer 30. Thus, the stress generated in the thin film by the expansion and contraction of silicon is hardly relaxed. Thus, the stress generated in the thin film may act on the negative electrode current collector 21. As a result, nickel contained in the negative electrode current collector 21 is incorporated into the thin film. This is probably the mechanism by which nickel in the negative electrode current collector 21 migrates into the thin film.

### EXAMPLES

The present disclosure will be described in detail below using examples and comparative example. The electrode materials and the batteries of the present disclosure are not limited to the following examples.

### Sample 1

### Preparation of Thin Film

First, a 12 μm thick electrolytic nickel foil was provided. Nickel was further electrolytically deposited onto the surface of the electrolytic nickel foil. A surface-roughened electrolytic nickel foil was thus obtained. The electrolytic nickel foil obtained was used as a negative electrode current collector. The thickness of the negative electrode current collector was 18 μm. The arithmetic average roughness Ra of the surface of the negative electrode current collector was measured with a laser microscope to be 1.3 μm.

Next, a silicon thin film was formed on the negative electrode current collector with use of an RF sputtering device. Argon gas was used for the sputtering. The pressure of argon gas was 0.24 Pa. Thus, a structure was obtained that was composed of the negative electrode current collector and the thin film including silicon as a main component. In Sample 1, the mass of silicon per area of the thin film was 1.37 mg/cm². The mass of silicon per area of the thin film was determined by inductively coupled plasma (ICP) emission spectroscopy.

### Preparation of Sulfide Solid Electrolyte Material

In an argon atmosphere glove box having a dew point of less than or equal to −60° C., Li₂S and P₂S₅ were weighed out in a mortar so that the molar ratio Li₂S:P₂S₅ would be 75:25. These were pulverized and mixed in the mortar to give a mixture. The mixture obtained was added to planetary ball mill P-7 manufactured by Fritsch Japan Co., Ltd. and was milled at 510 rotations per minute (rpm) for 10 hours to give a glass-like solid electrolyte. The glass-like solid electrolyte was heat-treated at 270° C. for 2 hours in an inert gas atmosphere. Thus, glass-ceramic solid electrolyte Li₂S—P₂S₅ was obtained.

### Preparation of Laminated Body

80 mg of the solid electrolyte was weighed out, added to an electrically insulating cylinder, and compacted at 50 MPa to form an electrolyte layer. Next, the above-described structure that had been punched out to a diameter of 9.4 mm was placed on the electrolyte layer. The diameter of the structure was equal to the inner diameter of the cylinder. In the cylinder, the thin film of the structure was in contact with the electrolyte layer. The unit was pressed at 370 MPa to give a laminated body having the negative electrode current collector, the thin film, and the electrolyte layer.

Next, In metal with a thickness of 200 μm, Li metal with a thickness of 300 μm, and In metal with a thickness of 200 μm were placed in this order on the electrolyte layer of the laminated body. Thus, a laminated body was prepared that had the negative electrode current collector, the thin film, the electrolyte layer, and an indium-lithium-indium layer. Next, the laminated body was pressed at 80 MPa to form a laminated body having the negative electrode current collector, the thin film, the electrolyte layer, and the counter electrode. Next, current collectors including stainless steel were arranged on and under the laminated body, and current collector leads were attached to the current collectors. Next, the inside of the electrically insulating cylinder was isolated from the outside atmosphere and was sealed with use of an electrically insulating ferrule. The laminated body was sandwiched vertically between substrates, and four bolts were tightened so as to apply a pressure of 150 MPa to the laminated body. Thus, a laminated body of Sample 1 was obtained. In the laminated body of Sample 1, the structure including the negative electrode current collector and the thin film functions as the working electrode.

### Charge-Discharge Test

Next, the laminated body of Sample 1 was subjected to a charge-discharge test under the following conditions. In the charge-discharge test, the laminated body was placed in a thermostatic chamber at 25° C.

### Evaluation of Initial Charge and Discharge Capacities

The theoretical capacity of silicon as the negative electrode active material is 4200 mAh/g. The laminated body of Sample 1 was charged at a constant current that was 20-hour rate (0.05 C rate) for a capacity of 3000 mAh/g corresponding to approximately 70% of the above theoretical capacity. The charging was terminated when the potential of the working electrode reached −0.62 V versus the counter electrode. Next, the laminated body was discharged at a current corresponding to 0.05 C rate to a voltage of 1.4 V. By the charging and discharging of the laminated body, a negative electrode active material layer was formed from the thin film. A battery was thus obtained. This battery was a bipolar electrochemical cell. The initial discharge capacity obtained was converted to a value per unit mass of silicon. The results are described in Table 1.

### Evaluation of Charge-Discharge Cycle Characteristics

After the evaluation of the initial charge and discharge capacities, the battery was tested to evaluate charge-discharge cycle characteristics. Specifically, the battery was charged at a constant current of 0.3 C for a capacity of 3000 mAh/g. The constant current charging was terminated when the potential of the working electrode reached −0.62 V versus the Li—In counter electrode. Next, the battery was charged at a constant voltage of −0.62 V until the current attenuated to 0.05 C. Next, the battery was discharged at a current corresponding to 0.3 C rate to a voltage of 1.4 V. This cycle of charging and discharging was repeated 500 times. The ratio of the discharge capacity in the 500th cycle to the initial discharge capacity was determined as the capacity retention rate. The results are described in Table 1.

### Sample 2

A laminated body of Sample 2 was prepared in the same manner as in Sample 1, except that an electrolytic copper foil covered with a nickel coating layer was used as the negative electrode current collector. The negative electrode current collector used in Sample 2 was prepared in the following manner. First, a 35 μm thick electrolytic copper foil was provided. Nickel was further electrolytically deposited onto the surface of the electrolytic copper foil. An electrolytic copper foil covered with a nickel coating layer was thus obtained. The thickness of the negative electrode current collector was 46 μm. In the negative electrode current collector, the surface of the coating layer was rough. The arithmetic average roughness Ra of the surface of the coating layer was measured with a laser microscope to be 1.3 μm. In Sample 2, the mass of silicon per area of the thin film was 1.37 mg/cm². The mass of silicon per area of the thin film was determined by inductively coupled plasma (ICP) emission spectroscopy.

### Charge-Discharge Test

The laminated body of Sample 2 was charge-discharge tested in the same manner as in Sample 1. The results are described in Table 1.

### Sample 3

A laminated body of Sample 3 was prepared in the same manner as in Sample 1, except that an electrolytic copper foil was used as the negative electrode current collector. The negative electrode current collector used in Sample 3 was prepared in the following manner. First, a 35 μm thick electrolytic copper foil was provided. Copper was further electrolytically deposited onto the surface of the electrolytic copper foil. A surface-roughened electrolytic copper foil was thus obtained. This electrolytic copper foil was used as the negative electrode current collector. The thickness of the negative electrode current collector was 46 μm. The arithmetic average roughness Ra of the surface of the negative electrode current collector was measured with a laser microscope to be 0.6 μm. In Sample 3, the mass of silicon per area of the thin film was 1.37 mg/cm². The mass of silicon per area of the thin film was determined by inductively coupled plasma (ICP) emission spectroscopy.

### Charge-Discharge Test

The laminated body of Sample 3 was charge-discharge tested in the same manner as in Sample 1. The results are described in Table 1.

### Observation of Cross Sections of Negative Electrodes

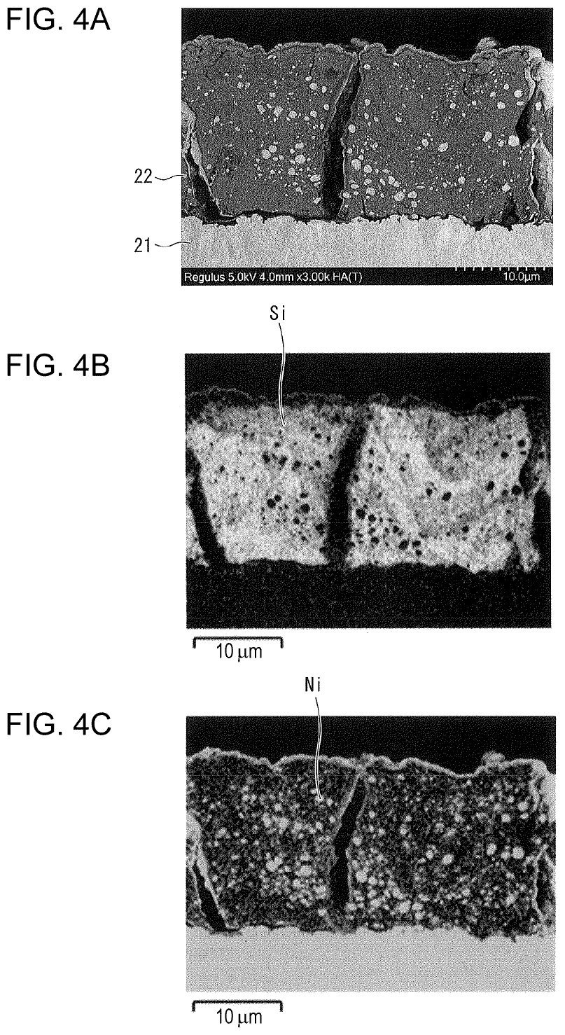

After the evaluation of charge-discharge cycle characteristics, the negative electrodes of the batteries of Samples 1 to 3 were cut and the cross sections thereof were observed. FIG. 4A is a scanning electron microscope (SEM) image of the cross section of the negative electrode in the battery of Sample 1. FIG. 4B is an image illustrating results of Si mapping on the SEM image of FIG. 4A. FIG. 4C is an image illustrating results of Ni mapping on the SEM image of FIG. 4A.

As can be seen from FIG. 4A, the negative electrode active material layer in the battery of Sample 1 was composed of a plurality of columnar bodies. As can be seen from FIG. 4B, the columnar bodies had a matrix including silicon. As can be seen from FIG. 4C, the columnar bodies had a filler including nickel. From FIG. 4C, it can be also seen that the filler including nickel is particles and that nickel is localized at a plurality of locations within the columnar bodies. There were no voids between the matrix and the filler in the columnar bodies. That is, the columnar bodies had a dense structure.

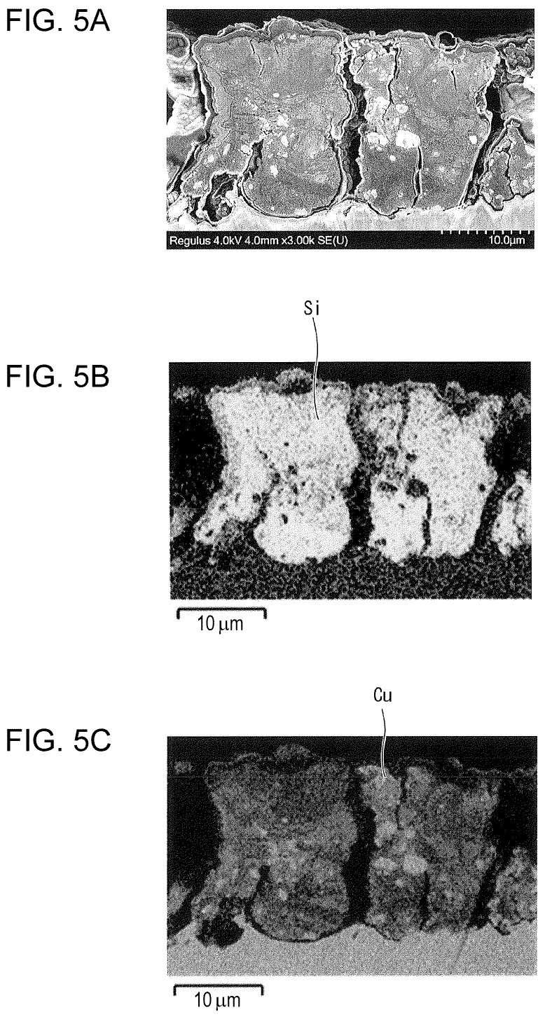

FIG. 5A is a SEM image of the cross section of the negative electrode in the battery of Sample 3. FIG. 5B is an image illustrating results of Si mapping on the SEM image of FIG. 5A. FIG. 5C is an image illustrating results of Cu mapping on the SEM image of FIG. 5A.

As can be seen from FIG. 5A, the negative electrode active material layer in the battery of Sample 3 was composed of a plurality of columnar bodies. As can be seen from FIG. 5B, the columnar bodies had a matrix including silicon. As can be seen from FIG. 5C, copper was dispersed throughout the columnar bodies.

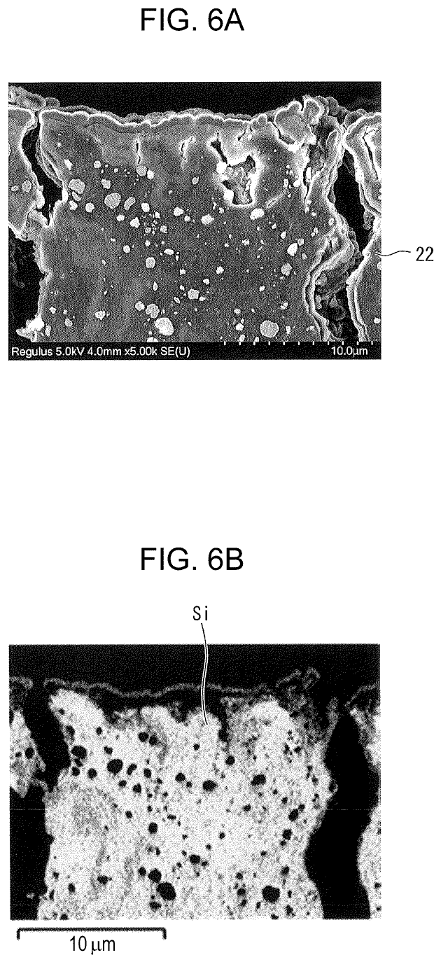

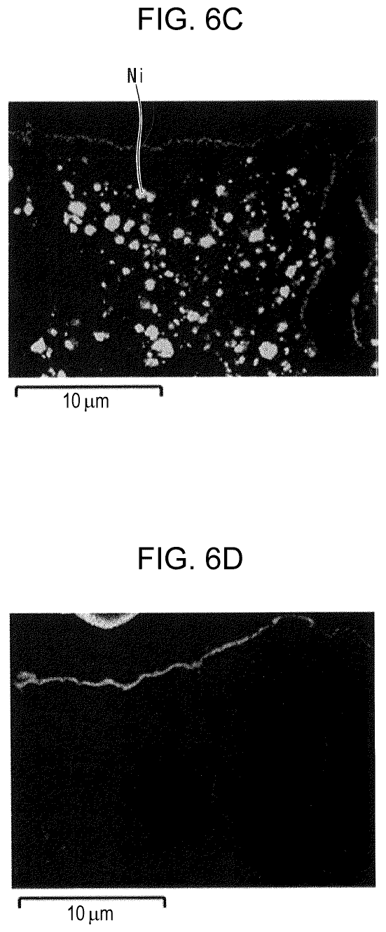

FIG. 6A is a SEM image of the cross section of the negative electrode in the battery of Sample 2. Specifically, FIG. 6A is an enlarged view of the columnar bodies in the negative electrode active material layer in the battery of Sample 2. FIG. 6B is an image illustrating results of Si mapping on the SEM image of FIG. 6A. FIG. 6C is an image illustrating results of Ni mapping on the SEM image of FIG. 6A. FIG. 6D is an image illustrating results of Cu mapping on the SEM image of FIG. 6A.

As can be seen from FIG. 6B, the columnar bodies had a matrix including silicon. As can be seen from FIG. 6C, the columnar bodies had a filler including nickel. As can be seen from FIG. 6D, copper was substantially absent in the inside of the columnar bodies. From the result of FIG. 6D, it is inferred that in Sample 2, the nickel coating layer inhibited the diffusion of copper from the electrolytic copper foil to the negative electrode active material layer.

TABLE 1

| | | | Capacity |
|---|---|---|---|
| | Negative electrode | Initial discharge | retention |
| Sample | current collector | capacity [mAh/g] | rate [%] |
| 1 | Surface-roughened | 3536 | 93.6 |
| | nickel foil | | |
| 2 | Copper foil covered | 3169 | 98.6 |
| | with surface-roughened | | |
| | nickel layer | | |
| 3 | Surface-roughened | 3549 | 63.5 |
| | copper foil | | |

As can be seen from Table 1, the batteries of Samples 1 to 3 had an initial discharge capacity per mass of silicon of greater than 3000 mAh/g. In Samples 1 and 2, the columnar bodies as the negative electrode active material layer included a nickel filler. The batteries of Samples 1 and 2 achieved a discharge capacity retention rate of greater than 90%. In contrast, the battery of Sample 3, in which the columnar bodies did not contain a nickel filler, had a discharge capacity retention rate of as low as 63.5%.

In Samples 1 and 2, nickel was localized at a plurality of locations within the columnar bodies as the negative electrode active material layer. According to this configuration, it is most likely that nickel was not detached from the columnar bodies and successfully maintained the function as a conductive material even when the volume of silicon changed significantly along with charging and discharging of the battery. This is probably the reason why the batteries of Samples 1 and 2 attained improvements in cycle characteristics. It can be said that the batteries of Samples 1 and 2 are excellent in long-term cycle characteristics.

In Sample 3, copper was dispersed throughout the columnar bodies. From this fact, it is inferred that copper diffuses easily inside silicon. Furthermore, in Sample 3, a slight amount of a sulfur component coming from the electrolyte layer was mixed into the negative electrode active material layer due to the long-term charging and discharging cycles. It is most likely that the sulfur component reacted with copper in the columnar bodies and formed a sulfide, such as CuS, that would increase the electrical resistance. This is probably the reason for the low battery capacity.

As described above, the negative electrode current collector used in Sample 2 was an electrolytic copper foil covered with a nickel coating layer. In Sample 2, the coating layer inhibited the mixing of copper from the electrolytic copper foil into the negative electrode active material layer. It is inferred that in Sample 2, the inhibition of copper inclusion inhibited the occurrence of undesired products, such as CuS.

For example, the battery of the present disclosure may be used as an automobile lithium ion secondary battery.

What is claimed is:

1. A battery comprising:
a positive electrode;
a negative electrode; and
an electrolyte layer located between the positive electrode and the negative electrode, wherein
the negative electrode includes a negative electrode current collector and a negative electrode active material layer located between the negative electrode current collector and the electrolyte layer,
the negative electrode active material layer comprises a plurality of columnar bodies,
the columnar bodies comprise silicon and a filler comprising nickel, and
the filler is embedded in the columnar bodies.

2. The battery according to claim 1, wherein
the columnar bodies comprise a matrix surrounding the filler, and
the matrix comprises the silicon.

3. The battery according to claim 1, wherein
the negative electrode active material layer is essentially free from an electrolyte.

4. The battery according to claim 1, wherein
the columnar bodies in the negative electrode active material layer are aligned along a surface of the negative electrode current collector.

5. The battery according to claim 1, wherein
the columnar bodies comprise the silicon as a main component.

6. The battery according to claim 1, wherein
the filler comprises the nickel as a main component.

7. The battery according to claim 1, wherein
the filler has a particulate shape.

8. The battery according to claim 1, wherein
the negative electrode current collector comprises nickel.

9. The battery according to claim 1, wherein
the negative electrode current collector comprises a substrate and a coating layer covering the substrate and comprising nickel.

10. The battery according to claim 1, wherein
the electrolyte layer comprises a solid electrolyte having lithium ion conductivity.

11. The battery according to claim 1, wherein
the electrolyte layer comprises a sulfide solid electrolyte.

12. A method for manufacturing a battery, comprising:
forming a thin film comprising silicon on a negative electrode current collector comprising nickel;
preparing a laminated body including the negative electrode current collector, the thin film, an electrolyte layer, and a positive electrode; and
forming a plurality of columnar bodies from the thin film by charging and discharging the laminated body, the columnar bodies comprising silicon and a filler comprising nickel.

13. The manufacturing method according to claim 12, wherein
the thin film is formed by depositing silicon onto the negative electrode current collector by a vapor-phase method.

14. The manufacturing method according to claim 12, wherein
the laminated body is charged and discharged while applying a pressure to the laminated body.
